(19) United States
(12) Patent Application Publication
(10) Pub. No.: US 2017/0203203 A1
(43) Pub. Date: Jul. 20, 2017

(54) DESIGN BUILD CONSTRUCTION GAME AND METHOD OF PLAYING THE SAME

(71) Applicants: Ronald David Bittner, Spring Valley, CA (US); Daniel K. Bittner, Mill Creek, WA (US)

(72) Inventors: Ronald David Bittner, Spring Valley, CA (US); Daniel K. Bittner, Mill Creek, WA (US)

(21) Appl. No.: 15/475,084

(22) Filed: Mar. 30, 2017

Related U.S. Application Data
(63) Continuation-in-part of application No. 14/863,345, filed on Sep. 23, 2015, now abandoned.
Application No. 14/863,345 is a continuation-in-part of application No. 13/811,243, filed on Apr. 3, 2013, now abandoned.
(60) Provisional application No. 61/365,680, filed on Jul. 19, 2010.

(51) Int. Cl. A63F 9/20; A63F 13/327; A63F 13/24; A63F 9/26; A63F 9/24

(52) U.S. Cl. CPC A63F 9/20; A63F 9/26; A63F 9/24; A63F 13/24; A63F 13/327; A63F 2250/50

(57) ABSTRACT

The present invention relates generally to a connecting game comprising a plurality tiles or bricks. The game is based on the aspects of building construction wherein the bricks have either a complimentary key or slot configuration. A successful connection is made and points scored when the key of one brick is connected to a slot of a second brick or vice versa. The game may be played horizontally at a beginner's level and for the more advanced player, in three-dimensional space not limited to merely stacking bricks flat but in numerous three dimensional connections and orientations. Each brick is played with the goal of making the most key to slot connections in a single move.

### CROSS REFERENCES

This application claims priority and benefit from copending U.S. Utility patent application Ser. No. 14/863,345 filed on Sept. 23 2015, which claims priority and benefit from U.S. Utility patent application Ser. No. 13/811,243 filed Apr. 3, 2013, which claims priority and benefit from U.S. Provisional Patent Application Ser. No. 61/365,680 filed Jul. 19, 2010 and further claims priority from International Application No. PCT/US2011/044473 with an international filing date of Jul. 19, 2011, and which applications are incorporated herein in their entirety by reference.

### FIELD OF INVENTION

The present disclosure generally relates to a tile connection family game, but more specifically, to a design, build, construction family game and method of playing the same in three-dimensional space to develop cognitive thinking and mental aptitude.

### BACKGROUND OF THE INVENTION

There are many games in existence which promote competition, provoke thought, or simply provide entertainment. Many games involve chance while others require skill and some games combine both chance and skill - one of the oldest games being Dominoes. Dominoes is a game consisting of tiles which have a set of pips on one side that are identifiable by color or number. A domino is played by matching the domino with an existing domino that has the same number of pips. Over time there have been many variations of the game Dominoes, which have been the subject of many U.S. patents. There have also been games invented where play is facilitated by forming a three dimensional structure. See for example U.S. Pat. No. 7,644,926 to Teeple and U.S. Pat. No. 6,893,020 to Snyder. In general known reference documents teach either building blocks with physical projections allowing only face to face vertical building (for example, U.S. Pat. No. 4,239,231 to Henderson), or domino type games which are enhanced only with face to face type vertical building or other non-related rules (U.S. Pat. No. 5,370,398), or even games which are not three dimensional at all but merely have different rows on a flat surface, the rows called “levels” or the like but not actually vertical unless the playing surface is vertical (US 2008/0318653 in the name of Lima et al, which has no stacking of tiles atop one another in any way and refers to “row / level” as being the same thing, lacks multi-planar play and so on) or even games with no apparent three dimensional element at all (U.S. Pat. No. 4,236,729 to Belony, US 2009/0322026 to Sun et al, US 2070228655 to Teeple). Note that U.S. Pat. No. 3,827,695 to Hess teaches a three dimensional building game with blocks, however, the blocks not only lack key bits and slot bits, they also lack edges (being the same depth as width) and thus cannot provide as many three dimensional combinations as blocks which differ in all three dimensions. In particular, the Hess blocks cannot be stacked with one end of one block resting on the long side of another block, because each wide block must span the entire width of the block below it. Hess furthermore lacks a “plane of the brick” since the brick has no narrower dimension.

No prior art known depicts three dimensional connections between bricks or tiles in which tiles may be perpendicular to one another, non-coplanar and so on. No prior art depicts three dimensional connections based upon a binary set of keys or slots: all known prior art teaches numbers of dots or numbers of bumps or elaborate patterns.

The present invention requires skill, promotes problem solving and is played as a competition. The game combines engineering, construction, mathematics, and foresight to successfully play the game. Players must strategize and configure their moves accordingly so as to acquire the most points possible. The level of difficulty can be adjusted so that players of all ages can enjoy playing the game. It has been found useful for occupational therapy as well as family entertainment.

### SUMMARY OF THE INVENTION

The present disclosure relates to a game and a method of playing the game. The game is based upon the aspects of building construction consisting of a plurality of bricks. Each brick is a playing tile having two sides and each side being divided up into two equal halves. There is a design or rather a bit on each half of the brick. The basic element of the game is to match key and slot design features or bits to make a successful connection.

In one aspect of the present disclosure, a design, build construction game includes a plurality of bricks. The bricks are substantially rectangular in shape having a top and a bottom surface, two long side surfaces, and two shorter end surfaces. Forming a part of at least one surface of each brick is at least one bit, the at least one bit having either a key or slot configuration. When the key of one brick is coupled to the slot of another brick, a connection is made and one point awarded for each proper key to slot connection.

In another aspect of the present disclosure, the game includes at least one playing rack for organizing a player's bricks and at least one game card including instructions and visual descriptions for playing a three-dimensional game.

In yet a further aspect of the present disclosure, the game is played electronically on a device selected from a member of the group consisting of mobile phone devices, smart phone devices, computing devices, mobile game stations, personal gaming devices, and arcade games. The game may be played by a plurality of players over a computer network, wherein the device is connected to the computer network by a cellular broadband connection, a cable modem, a DSL modem, a dial-up modem, or a wireless router.

In another aspect, a method of playing a design, build construction game is disclosed comprising the steps of each player and/or team selecting game bricks; positioning a first game brick representing the first player's move; a second player establishing a connection to the first game brick; the first player establishing a connection to the second player's connection; the first player and the second player alternating turns making connections among the game bricks; and awarding points to the first and the second player for a successful connection of the game bricks.

Yet another aspect, embodiment, advantage and objective of the present invention provides a method of playing a three dimensional construction family game, for at least first and second players, using a plurality of bricks, each brick having a top surface and a bottom surface, two sides and two ends, the bricks having a depth, width and length, the depth less than the width and the width less than the length, the top and bottom surfaces defined by the width and length, the sides defined by the length and depth and thus smaller in area than the top and bottom surfaces, the ends defined by the depth and width and thus smaller in area than the sides, the bricks defined to be flat when placed with either the top surface or bottom surface upward; the bricks defined to be upright when placed with either end upward; the bricks defined to be on the side when placed with either side upward; adjacent defined to mean a first and a second brick adjoining with neither brick resting on the other, and atop defined to mean the second brick resting on the first brick; wherein forming a part of the top surface of each brick is at least one bit, each bit having either a key or slot configuration, said method comprising the steps of:

each such player selecting a plurality of game bricks;

positioning a first game brick comprising the first such player's first turn;

the second such player taking a turn comprising establishing a connection to the first game brick by positioning a second brick so that at least one bit of the second brick is adjacent or atop at least one bit of the first brick, and at least one bit of one of the two bricks is a key while the bit of the other brick is a slot;

the first such player and the second such player continuing to play by alternating the turns, on each one of the turns placing one additional brick so as to establish an additional connection;

awarding points to the first such player and the second such player for establishing connections of the game bricks;

wherein the key of one brick and the slot of another brick may make at least the following types of connections, each type of connection being distinct:

both bricks flat,

the first brick flat and the second brick upright,

the first brick flat and the second brick upright and atop the end of the upper surface of the first brick,

the first brick flat and the second brick upright and atop a non-end portion of the upper surface of the first brick,

the first brick flat and the second brick on its side,

the first brick flat and the second brick on its side atop the upper surface of the first brick,

the first brick on its side and the second brick on its side and atop the first brick

Yet another aspect, embodiment, advantage and objective of the present invention provides a design and build construction family game for play in three dimensions building from a playing surface, the game comprising:

a plurality of bricks each brick having a top surface and a bottom surface, two sides and two ends, the bricks having a depth, width and length, the depth less than the width and the width less than the length, the top and bottom surfaces defined by the width and length, the sides defined by the length and depth and thus smaller in area than the top and bottom surfaces, the ends defined by the depth and width and thus smaller in area than the sides;

the bricks defined to be flat when placed with either the top surface or bottom surface upward;

the bricks defined to be upright when placed with either end upward;

the bricks defined to be on the side when placed with either side upward;

adjacent defined to mean a first and a second brick adjoining with neither brick resting on the other, and atop defined to mean the second brick resting on the first brick;

wherein forming a part of at least one top surface of each brick is at least one bit, the at least one bit having either a key or slot configuration;

a set of rules defining a connection to be made by positioning the second brick so that at least one bit of the second brick is adjacent or atop at least one bit of the first brick, and one brick's bit is a key while the bit of the other brick is a slot; and the bricks are oriented in any one of the following ways:

both bricks flat,

the first brick flat and the second brick upright,

the first brick flat and the second brick upright and atop the end of the upper surface of the first brick,

the first brick flat and the second brick upright and atop a non-end portion of the upper surface of the first brick,

the first brick flat and the second brick on its side,

the first brick flat and the second brick on its side atop the upper surface of the first brick,

the first brick on its side and the second brick on its side and atop the first brick.

Yet another aspect, embodiment, advantage and objective of the present invention provides a design, build construction game for play in three dimensions, the game comprising: a set of rules, a plurality of bricks each brick having at least one long side surface, at least one upper/top surface, and at least one shorter end surface, wherein forming a part of at least one upper surface of each brick is at least one bit, the at least one bit having either a key or slot configuration, and wherein when the key of one brick is coupled to the slot of another brick, a connection is made, and further wherein the key of one brick and the slot of another brick may within the rules of the game make at least the following types of connections, each type of connection being distinct:

both bricks flat and adjacent at the connection,

one brick flat and the other brick adjacent and upright at the connection,

one brick flat and the other brick atop the end of the upper surface and upright at the connection,

one brick flat and the other brick atop a non-end portion of the upper surface and upright at the connection,

one brick flat and the other brick adjacent and on the side at the connection,

one brick flat and the other brick on the side atop the upper surface at the connection,

one brick on the side and the other brick on the side and atop at the connection.

Yet another aspect, embodiment, advantage and objective of the present invention provides a design, build construction game for play in three dimensions, wherein the plurality of bricks are substantially rectangular in shape and having bottom surface, a second side surface, and a second end surfaces.

Yet another aspect, embodiment, advantage and objective of the present invention provides a design, build construction game for play in three dimensions, wherein a mirror image of the at least one bit forming a part of the top surface forms a part of the bottom surface.

Yet another aspect, embodiment, advantage and objective of the present invention provides a design, build construction game for play in three dimensions, wherein each brick includes a plurality of bits.

Yet another aspect, embodiment, advantage and objective of the present invention provides a design, build construction game for play in three dimensions, wherein each brick includes between 2 and 8 bits.

Yet another aspect, embodiment, advantage and objective of the present invention provides a design, build construction game for play in three dimensions, wherein each brick includes 8 bits.

Yet another aspect, embodiment, advantage and objective of the present invention provides a design, build construction game for play in three dimensions, wherein each brick is partitioned into equal halves, each half including at least one bit.

Yet another aspect, embodiment, advantage and objective of the present invention provides a design, build construction game for play in three dimensions, wherein each half includes a plurality of bits.

Yet another aspect, embodiment, advantage and objective of the present invention provides a design, build construction game for play in three dimensions, wherein each half includes between 2 and 4 bits.

Yet another aspect, embodiment, advantage and objective of the present invention provides a design, build construction game for play in three dimensions, wherein each half includes 4 bits.

Yet another aspect, embodiment, advantage and objective of the present invention provides a design, build construction game for play in three dimensions, wherein a plurality of connections forms a three dimensional structure.

Yet another aspect, embodiment, advantage and objective of the present invention provides a design, build construction game for play in three dimensions, wherein the game includes at least 50 bricks.

Yet another aspect, embodiment, advantage and objective of the present invention provides a design, build construction game for play in three dimensions, wherein there is a plurality of bit configurations.

Yet another aspect, embodiment, advantage and objective of the present invention provides a design, build construction game for play in three dimensions, wherein the plurality of bricks are designed with a visual indicator, the visual indicator selected from at least one member of the group consisting of color, design, letters, texture, and numbers.

Yet another aspect, embodiment, advantage and objective of the present invention provides a design, build construction game for play in three dimensions, wherein the plurality of bricks includes electronic components selected from at least one member of the group consisting of a sound emitting device, illumination device, and a radio frequency identifier chip.

Yet another aspect, embodiment, advantage and objective of the present invention provides a design, build construction game for play in three dimensions, wherein the game is played electronically on a device selected from a member of the group consisting of mobile phone devices, smart phone devices, computing devices, mobile game stations, personal gaming devices, and arcade games.

Yet another aspect, embodiment, advantage and objective of the present invention provides a design, build construction game for play in three dimensions, wherein the game is played by a plurality of players over a computer network, wherein the device selected from a member of the group consisting of mobile phone devices, smart phone devices, computing devices, mobile game stations, personal gaming devices, and arcade games is connected to the computer network by a cellular broadband connection, a cable modem, a DSL modem, a dial-up modem, or a wireless router.

Yet another aspect, embodiment, advantage and objective of the present invention provides a design, build construction game comprising: a plurality of bricks having top / upper and bottom surfaces, a plurality of sides and a plurality of ends, wherein forming a part of the top and bottom surface of each brick is at least one bit, the at least one bit having either a key or slot configuration, and wherein when the key of one brick is coupled to the slot of another brick, a connection is made; at least one playing rack for organizing a player's bricks; at least one game card including instructions and visual descriptions for playing a three-dimensional game; and further comprising a set of rules, wherein the key of one brick and the slot of another brick may within the rules of the game make at least the following types of connections, each type of connection being distinct:

both bricks flat and adjacent at the connection,

one brick flat and the other brick adjacent and upright at the connection,

one brick flat and the other brick atop the end of the upper surface and upright at the connection,

one brick flat and the other brick atop a non-end portion of the upper surface and upright at the connection,

one brick flat and the other brick adjacent and on the side at the connection,

one brick flat and the other brick on the side atop the upper surface at the connection,

one brick on the side and the other brick on the side and atop at the connection.

Yet another aspect, embodiment, advantage and objective of the present invention provides a method of playing a design, build construction game, for first and second players, said method comprising the steps of: each such player and/or team selecting game bricks having thereon at least one bit, each bit having thereon at least one key / lock; positioning a first game brick representing the first such player's move; a second such player establishing a connection to the first game brick; the first such player establishing a connection to the second such player's connection; the first such player and the second such player alternating turns making connections among the game bricks; and awarding points to the first and the second such players for a successful connection of the game bricks, wherein the key of one brick and the slot of another brick may make at least the following types of connections, each type of connection being distinct:

both bricks flat and adjacent at the connection,

one brick flat and the other brick adjacent and upright at the connection,

one brick flat and the other brick atop the end of the upper surface and upright at the connection,

one brick flat and the other brick atop a non-end portion of the upper surface and upright at the connection,

one brick flat and the other brick adjacent and on the side at the connection,

one brick flat and the other brick on the side atop the upper surface at the connection,

one brick on the side and the other brick on the side and atop at the connection.

It is contemplated that any method, system or information described herein can be implemented with respect to any other method, system or information described herein.

Unless otherwise defined, all terms used herein have the same meaning as commonly understood by one of ordinary skill in the art to which this invention belongs. Methods and materials are described herein for use of the present invention; other suitable methods and materials known in the art can also be used. The materials and methods, and examples are illustrative only and not intended to be limiting. All publications, patent applications, patents and other references mentioned herein, are incorporated by reference in their entirety. In case of conflict, the present specification, including definitions will control.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein.

FIG. 1 illustrates a fifty brick game set with varying bit designs on each brick;

FIG. 2 illustrates a key and slot connection between a first and second brick;

FIG. 3A illustrates both horizontal and vertical brick positions to make connections;

FIG. 3B illustrates vertical brick positions to make connections;

FIG. 4 illustrates game card contents for the Structural game containing instructions and pictures of a three-dimensional structure;

FIG. 5 illustrates game card contents for the Challenge game containing instructions and pictures of a three-dimensional structure;

FIG. 6 is illustrative of the varying ways to advance to another level in the Strategy game;

FIG. 7 is illustrative of what the Strategy game may look like after several phases of play.

FIG. 8 is a diagram of a single brick, defining zones of the brick including the top surface, the long side, the end, the part of the brick which is atop the end, the part of the brick which is atop the long side, a part of the brick which is atop the brick but intermediate between the ends, as well as the long axis, the short axis, and the plane of the brick.

### DETAILED DESCRIPTION OF THE INVENTION

Glossary

A game as used herein refers to entertainment or diversion, although the present game has been found useful in the occupational therapy area as well in a VA facility.

A design and build construction family game as used herein refers to the piece by piece building of a three dimensional structure (such as those depicted in the diagrams) from a large number of smaller pieces, in this case bricks. Family refers to the fact that the game is intended to be suitable for children and can be played reasonably equally between an adult and a child.

The term construction indicates that the bricks become structural elements, holding up other bricks on top of them. This is in contrast to prior art such as Nguyen for example, which discuss “layers” but actually refer only to flat play in different rows and columns.

The game is three dimensional, unlike a dominos style game, in that the bricks are used to build structures. A playing surface (defined to be a table, floor, countertop or the like) is the base on which the first brick rests, other bricks may be placed adjacent the first brick or atop earlier placed bricks.

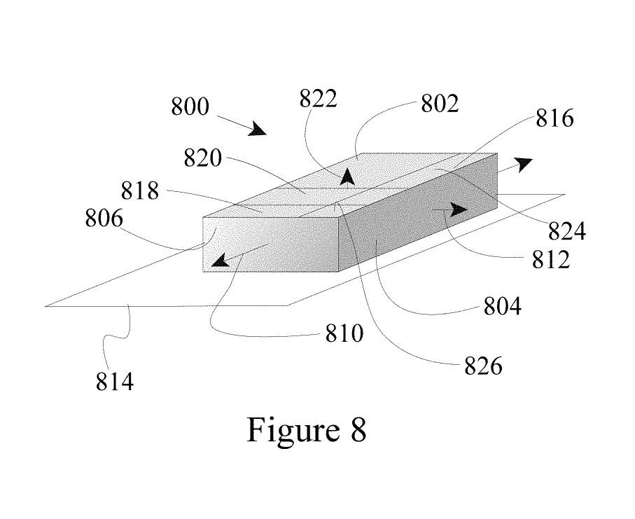

A brick as used herein refers to a single block or brick. FIG. 8 is a diagram of a single brick, defining zones of the brick including the top surface, the long side, the end, the part of the brick which is atop the end, the part of the brick which is atop the long side, a part of the brick which is atop the brick but intermediate between the ends, as well as the long axis, the short axis, and the plane of the brick. The bottom surface, other side and other end are identical to the pictured surfaces of FIG. 8.

As may be seen, block 800 is a three dimensional rectanguloid body. It has a long axis 810 and a short axis 812. Note that it has an even shorter axis 822. The depth of the block 800 along axis 822 is less than the width of the block along axis 812, while the width is in turn less than the length along axis 810. For clarity, these axes are not shown within the block. The block thus has length along axis 810, width along axis 812, and depth along axis 822, all three being different in measure. The top and bottom surfaces are defined by the width and length, the sides defined by the length and depth and thus smaller in area than the top and bottom surfaces, the ends defined by the depth and width and thus smaller in area than the sides, all as very clearly shown in FIG. 8.

Because the depth of the block is shorter than the width and length it is possible to define the plane of the block 814. For clarity the plane of the block is offset from axes 810 and 812 in the diagram. Furthermore the block 800 also has top and bottom surfaces as it sits flat in its plane, top surface 802 is depicted, the bottom surface cannot be seen. The top and bottom surfaces may be the largest surfaces of the block, which intersect the shortest axis of the block.

Block 800 further has “sides” (also “long sides”) including side 804. The sides of the block 800 are the second largest surfaces of the block, which intersect the axis 812.

Block 800 further has “ends” (also “short sides”) including end 806. It may be seen from FIG. 8 that the ends are the smallest surfaces of the block 800, and that they intersect the longest axis 810.

In simpler language, each brick has six standard surfaces, top, bottom, two long narrow side surfaces and two narrow end surfaces. Being longer than it is wide, and wider than it is deep, the brick has a “long axis”, “long sides”, etc. The header and footer are on the top and bottom surface, however, the side surfaces and end surfaces are used in the game and in the claims thereto.

The bricks are defined to be flat when placed with either the top surface or bottom surface upward and the other surface resting on a lower brick or the playing surface; and the bricks are defined to be upright when placed with either end upward, resting on the other end.

The bricks are defined to be on the side when placed with either side upward, resting on the opposite side atop another brick or the playing surface.

In addition, it may be seen that certain areas of the block 800 may be defined. In particular, the top surface 802 may be subdivided into an area “atop the end” 818. This area spans the width of the top surface 802 of block 800 from long side to long side at one end 806, and may be approximately the same size and shape as the end 806. Thus a second block may be stood on end 806 and placed atop area 818, “atop the end” of the block.

The top surface 802 may also have area 820 “atop a non-end portion of the block”. This area 820 also spans the width of the top surface 802 of block 800 from long side to long side as shown, but not at end 806. This area 820 may also be approximately the same size and shape as the end 806. Thus a second block may be stood on its end 806 and placed atop area 820, “atop a non-end portion of the block”.

The top surface 802 may yet further have area 816, subdivided into areas 824 and 826. (The line dividing area 818 from area 820 cuts across the middle of area 826, however, area 826 is not so divided, areas 824 and 826 extend the entire length of area 816.) This area 816 may span the length of the block 800 from end to end as shown, along that part of the top surface which is adjacent to side/long side 804. The area 816 may also be approximately the same size and shape as side 804, so that a second block may be stood on its side 804 and placed atop area 816, “one brick flat and the other brick on the side atop the upper surface”. In addition, the second block might be stood on its end 806 and placed into area 824 or area 826, each comprising approximately one half of the length of the block 800.

The term “adjacent” as used herein has its normal meaning that two things (bricks) are adjoining, and bordering. The term “touching” may be used in this context, although some slight separation may exist, “touching” and “adjacent” may be used as synonyms. Bricks may be adjacent in three dimensional space, and may be adjacent even if only one half of a long side is bordering another brick. Bricks may also be adjacent when one brick rests on the appropriate bit of another brick, and may be adjacent when one the connection between the bricks is made at dissimilar sides of the bricks, for example, a key on the end of one brick is matched to a slot bit on one half of the long side of another brick. Note that even then, there are numerous possibilities: the brick on end may be standing upright on the playing surface and with the end bit touching one half of the long side of the other brick laying flat, or, the upright brick may rest upon the appropriate bit of the flat brick, or, the other brick may not be flat at all but standing on edge with the upright brick resting on the edge at the bit, and so on and so forth.

“Atop” is a special case of adjacent, in which one brick rests on another brick rather than on the playing surface. Various locations for being atop, such as “atop the end of the upper surface” are defined above.

“Upward” carries the normal meaning of uppermost, oriented so as to face up, etc.

As used herein the terms Header / Footer refer to one half of a brick or tile. The tile being rectangular, approximately twice as long as it is wide, each Header or Footer take up one half the brick, put together they take up the full top or bottom surface of the brick. The areas 818 and 820 combined approximately define one header or footer of block 800 while the remaining area of the top surface 802 forms the other footer or header of the block 800.

Each header or footer may have thereon a rectangular pattern, the term rectangle as used herein and as normally mathematically defined includes squares (rectangles having four sides of equal length). The four sides are each interrupted by one key bit or slot bit, so the rectangular shape is interrupted by four (or in alternative embodiments fewer than four) bits.

Key bit as used herein refers to a small extension from the side of the rectangle, which extension is itself generally rectangular.

Slot bit as used herein refers to a small indentation into the side of the rectangle, and the indentation is also generally rectangular. The player, seeing key bits and slot bits, might immediately gain the understanding that a key bit and a slot bit conceptually fit together, but a slot bit and a slot bit, or a key bit and a key bit do not.

The set of rules of the game is provided herein in both examples and text.

Establishing a connection as used herein refers to a situation in which a first brick is visible and already in play and a player places a second brick beside or atop the first brick, with at least one key of one of the two bricks adjoining at least one slot of the other of the two bricks. Note an important distinction. In domino type games dominos are placed substantially flat: the dominos may be flat beside one another, or they may be stacked flat atop one another, but they are normally flat. This limitation is not present in the present invention. A number of three dimensional configurations may establish a connection between the bricks of the present invention, such as one brick flat and another one adjacent and upright, or one brick upright standing on edge or end and the second upright and atop the edge of the first. Thus the long axis of one brick may parallel the play surface (a table top, floor, or the like) while the other brick may have a long axis which is vertical, non-parallel, and entirely out of plane therefrom. A number of possible connections made by a key+slot combination on two adjacent bricks are laid out below, and shown by example in the figures. A number of larger structures are depicted in the figures showing the cumulative effect of using numerous of such non-flat three dimensional connections repetitively.

Thus a connection is a key and slot combination between two adjacent bricks, which may further include a three dimensional element of the bricks having their long axes out of plane from one another and non-parallel according to certain sets. The term “connection” as commonly understood may refer to this relationship (key and slot between two adjacent brick), or also as commonly understood may refer to the parts of the connection. (A USB port may be referred to as a “connection” and plugging a computer peripheral into a USB port may be referred to as a “connection”, both are common and normal English usages.) The term “point of connection” will be used to refer to that part of two bricks at which they are adjacent, or touching.

In general then, three rules must be met to have a connection: 1) positioning the second brick so that at least one bit of the second brick is adjacent or atop at least one bit of the first brick, and 2) one brick's bit is a key while the bit of the other brick is a slot; and 3) the bricks are oriented in any one of the following ways defined in the next paragraphs.

Thus, the key of one brick and the slot of another brick may within the rules of the game make at least the following types of connections, each type of connection being distinct:

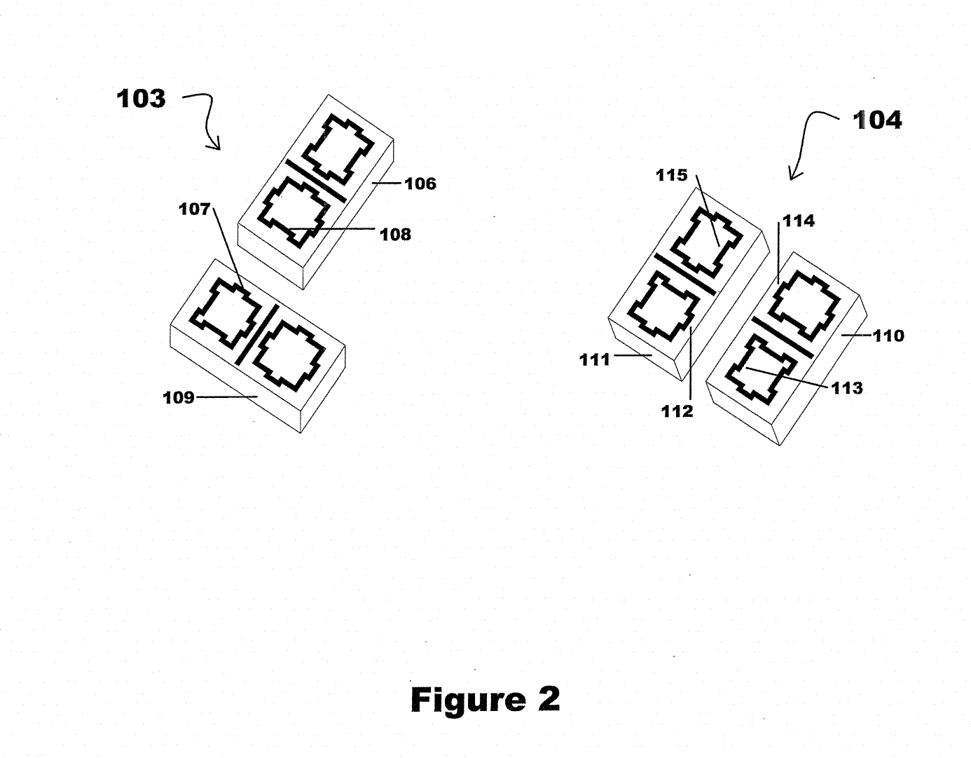

both bricks flat and adjacent at the connection, in a manner similar to a domino game, with their long axes both horizontal and either parallel or perpendicular (examples of this may be seen in FIG. 2);

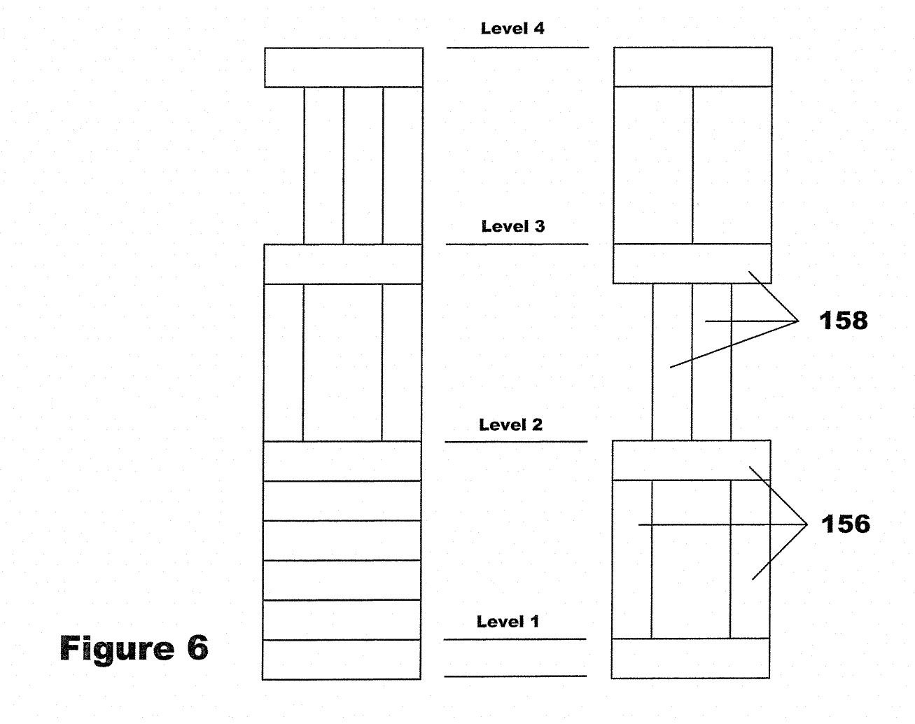

both bricks flat and horizontal, one brick stacked atop another, such as might be seen if the bricks are simply stacked, with both bricks' long axes being horizontal (such as shown low down between levels one and two of one side of FIG. 6);

and specifically including the following methods of key+slot combinations, which are considerably more involved in three dimensions and frequently have brick axes which are non-co-planar:

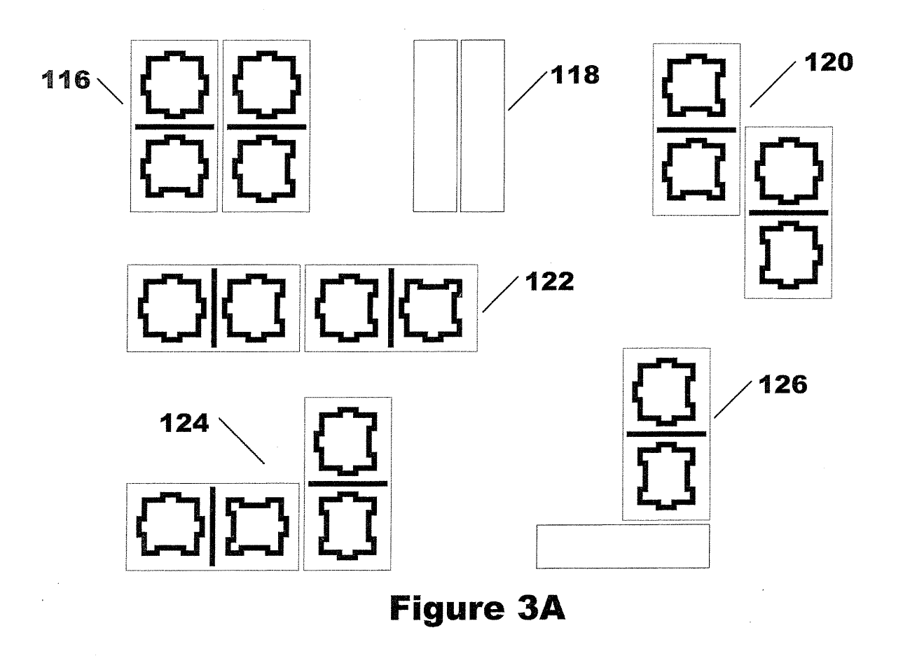

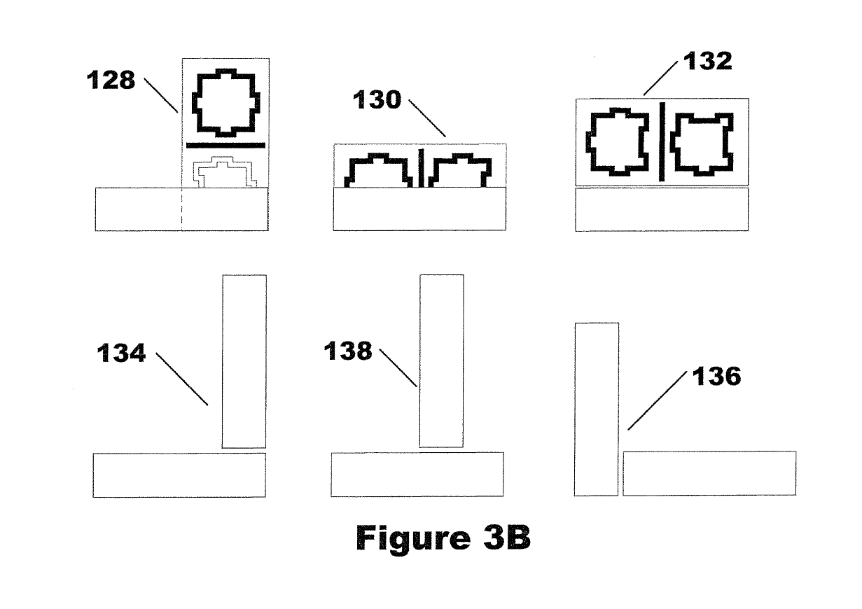

one brick flat on the playing surface and the other brick adjacent and upright at the connection thus one brick having a long axis which is horizontal and one brick having a long axis which is vertical, the upright brick resting on the playing surface and touching/bordering the flat brick, the upright brick being disposed either at one half of the long side of the flat brick (axes non-coplanar) (for example as shown in FIG. 3B, reference numeral 128) or at one end of the upright brick (axes coplanar in a vertical plane perpendicular to the horizontal plane of the playing surface) (for example as shown in FIG. 3B, reference numeral 136), depending on the bit chosen by the player for the connection;

one brick flat and the other brick atop the end of the upper surface and upright at the connection, thus the long axes of the bricks are coplanar in a vertical plane perpendicular to the plane of the playing surface, and the second brick actually rests, upright, upon the first brick, standing at one end thereof, and one example of this may be seen at reference numeral 134 of FIG. 3B;

one brick flat and the other brick atop a non-end portion of the upper surface which is one half of a long side of the lower brick, the second brick upright at the connection with the axes thus coplanar (see numeral 138 of FIG. 3B for an example);

one brick flat and the other brick adjacent (but not resting atop it) and on the side at the connection, such as might be shown by example 130 of FIG. 3B;

one brick flat and the other brick on the long side side atop the upper surface of the lower brick at the connection, such as might be exemplified by 132 of FIG. 3B, this particular configuration is not shown in any prior art as the bricks of the prior art are either equal in depth and width and thus cannot physically stand on one side of another brick, or are domino style games with no three dimensional stacking at all;

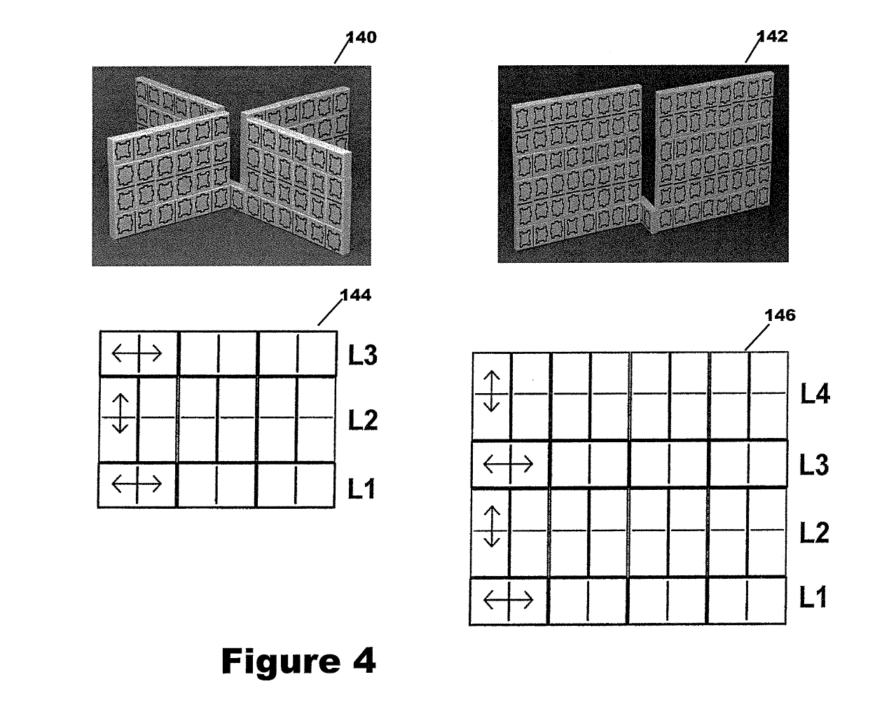

one brick resting on its long side and the other brick also on its own long side and atop the first brick's long side at the connection, or one brick resting on its long side and the other brick on end atop one half of the first brick's long side at the connection, (this pattern is exemplified by FIG. 4, showing various patterns of wall which may be so constructed).

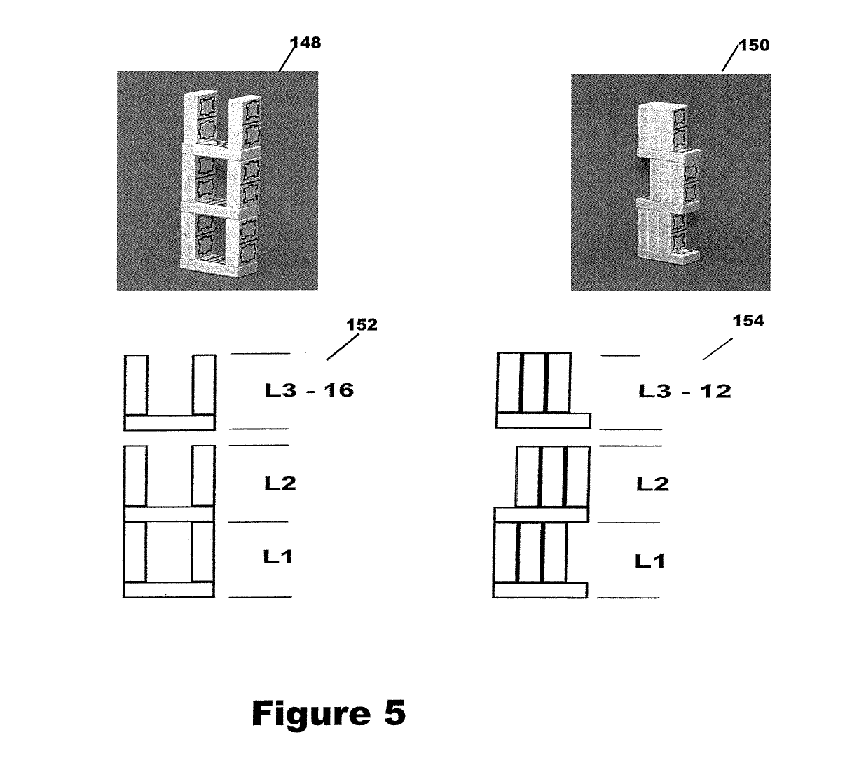

While the bricks are of necessity shown with one side in view, it will be understood that the bricks may have bits on both sides, thus allowing face to face stacking (as discussed previously in this glossary) or face to face standing as depicted in FIGS. 3B (118) or in FIGS. 5, 6 and 7.

Edge to edge stacking may refer to either long edge to long edge stacking, end to end stacking, or long edge to end stacking (see FIG. 4).

For purposes of this glossary, a term used in the claims hereto has been re-stated, explained, the three dimensional nature of the connection established discussed and example diagrams are depicted. Further names for each position are provided in the detailed discussion below and these can be added to the claims.

End Glossary

The present disclosure relates to a game and a method of playing the game. The game and method of playing the game will be described in relation to using bricks as presently disclosed. However, it will be appreciated that, with minor modifications, the game and method may be adapted for use with other forms or designs of bricks.

A brick is generally rectangular in shape and may be partitioned into equal halves. Each brick has a top and bottom surface, two long side surfaces, and two end surfaces. The top surface of a brick will contain a plurality of bits, preferably between 2 and 8 bits, and more preferably 8 bits.

Bits may be grouped on each half of the partitioned brick in a generally rectangular puzzle piece like design, with each side of the rectangle interrupted by a small projection (key) or small indentation (slot). By the term bit is meant either a key or slot designation. Thus, referencing the top surface, each half of the brick contains a plurality of bits, preferably between 2 and 4 bits, and more preferably 4 bits of varying key and slot designations. The bit design on the bottom surface is a mirror image of the bit design shown on the top surface. The object of the game is to make connections by matching a key on a first brick with a slot on a second brick or vice versa.

A standard game may include a set of fifty bricks. The set may have some type of visual identifier to indicate the set of fifty bricks belongs to one set. The visual identifier could be color, initials, names, logos, pictures or any other distinguishing feature. Thus, it is contemplated that game sets may be combined to increase the number of players, length of play, and game complexity.

In one alternative embodiment, bricks may have either one or two colors, such as a brick which is white on both header and footer, or blue on both, or one of the header or footer is white and the other blue. This allows for an increase in the complexity of the game and the difficulty of making connections, when in embodiments color rules are used for connections.

Because the game and method of playing the game using a set of at least fifty bricks is a construction game, the number and variation of games playable is limitless. In a preferred embodiment, the game includes progressively more difficult game variations. The game variations in increasing difficulty are the Basic game, the Structure game, the Challenge game, and the Strategy game, which all will be discussed in detail hereinafter.

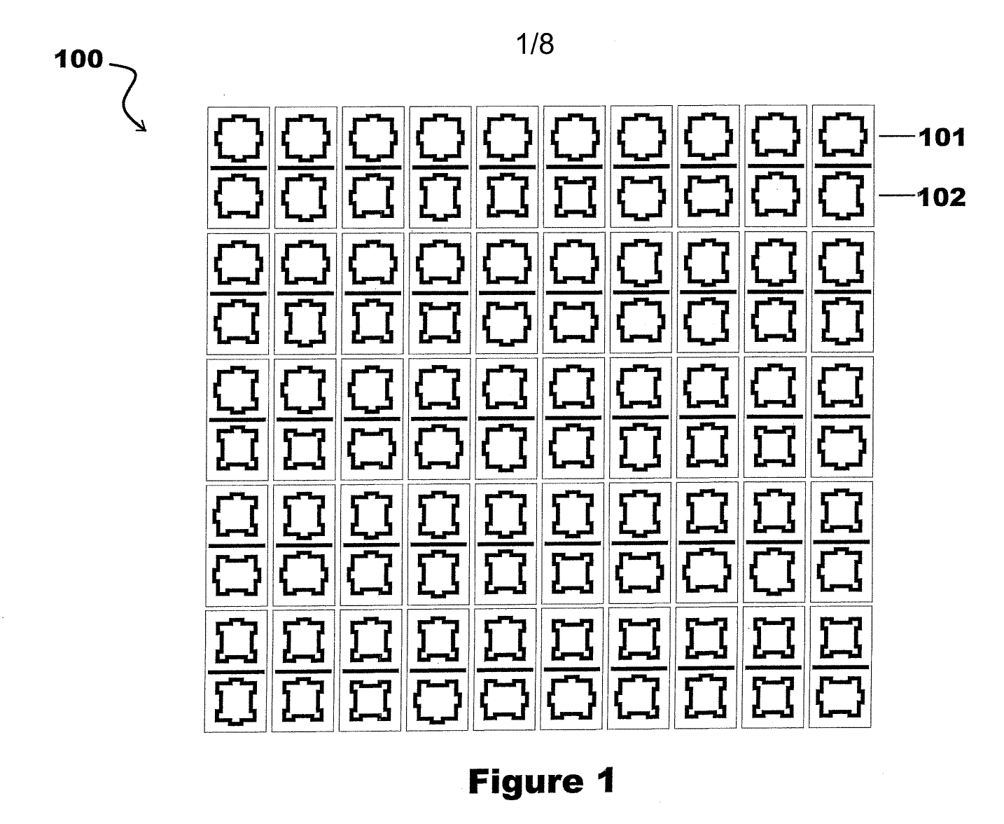

Referring now to FIG. 1, illustrative of a complete fifty brick game set. The game set 100 contains at least fifty bricks with each brick having two sections or halves called a header 101 and footer 102. Each header and footer contains at least one bit, preferably a plurality of bits, more preferably between 2 and 4 bits, and most preferably 4 bits. In a preferred embodiment, the header suit has seven distinct bit patterns and the footers are made up of eight variable bit patterns. In alternative embodiments, the header and footers are made up of at least one bit each. The purpose of the header and footer pattern is to provide various options for connecting bits for points.

Referring now to FIG. 2, illustrative of connecting bits via a key to slot connection to score points. In a preferred embodiment, to make a play each brick must connect to another brick using one or more of the eight bits. A match of a key bit of one brick and slot bit of another brick is considered a connection. A connection is counted as one point. Once a connection is made, the connected bits cannot be used again for scoring. Note that two connections may be made, if both header and footer connect, and in situations in which a brick fits multiple previously laid bricks, more than two points may be scored.

Scoring need not be restricted to one point per one connection. In one presently preferred embodiment, points may be determined by multiplying the number of connections made by other factors.

An example of making connections is illustrated in FIG. 2. A connection 103 is made between a first brick 106 and a second brick 109 via a key bit 107 to slot bit 108 connection for one point. A further example illustrates a two point connection 104 whereby two connections are made between a first brick 110 and a second brick 111 using two bits on the first brick 110 via a slot bit 113 and key bit 114 to connect to a key bit 112 and slot bit 115, respectively, on the second brick 111.

Referring now to FIGS. 3A & 3B, illustrative of possible connecting positions between key bits and slot bits for use in the Strategy game. The connection of the bits can be one of the following or any combination thereof

Side to side 116
Face to face 118
Half side to half side 120
End to end 122
End to side 124
End to top side 126
End to flat side 128
Side to flat side 130
Side to top side 132
End to top end 134
End to flat end 136
End to inside top 138

End to flat side 128 teaches an example of three dimensional stacking unique to the invention in which one brick flat on the playing surface and the other brick adjacent and upright at the connection thus one brick having a long axis which is horizontal and one brick having a long axis which is vertical, the upright brick resting on the playing surface and touching / bordering the flat brick, the upright brick being disposed either at one half of the long side of the flat brick (axes non-coplanar).

End to flat end 136 shows an example or at one end of the upright brick (axes coplanar in a vertical plane perpendicular to the horizontal plane of the playing surface).

End to top end 134 is an example of one brick flat and the other brick atop the end of the upper surface and upright at the connection, thus the long axes of the bricks are coplanar in a vertical plane perpendicular to the plane of the playing surface, and the second brick actually rests, upright, upon the first brick, standing at one end thereof.

End to inside top 138 is another example of a type of three dimensional stacking of the invention in which one brick is flat and the other brick sits atop a non-end portion of the upper surface—which non-end portions is one half of a long side of the lower brick—the second brick upright at the connection with the axes thus coplanar.

Side to flat side 130 shows another type of three dimensional connection of the invention: one brick flat and the other brick adjacent (but not resting atop it) and on the side at the connection.

Side to top side 132 may be one brick flat and the other brick on the long side side atop the upper surface of the lower brick at the connection.

In FIG. 4, one brick may be seen to be resting on its long side and the other brick also on its own long side and atop the first brick's long side at the connection, or in embodiments one brick may rest on its long side and the other brick on end atop one half of the first brick's long side at the connection. It will immediately be seen that elaborate combinations of walls may be constructed within the rules of the game, thus adding additional levels of complexity. Edge to edge stacking may refer to either long edge to long edge stacking, end to end stacking, or long edge to end stacking.

While the bricks are of necessity shown with one side in view, it will be understood that the bricks may have bits on both sides, thus allowing face to face stacking (as discussed previously in the aforelocated glossary) or face to face standing as depicted in FIGS. 3B (118) or in FIGS. 5, 6 and 7. At this point the structures created may be considered to be fanciful, yet the rules of the game control where bricks may be placed and where they may be optimally positioned.

In use, it has been found that cognitive abilities are improved by playing the game of the invention as young players must learn spatial relationships, basic math and more in order to play, and yet the use of these skills is encouraged by positive reinforcement rather than by mandate.

In the Basic game, because the game is played horizontally or flat the connecting positions illustrated in FIG. 3A, 116, 120, 122, or 124 will be used. In the Strategy game, which introduces the vertical aspects of the disclosed game, all connecting positions in FIGS. 3A and 3B are available for use after the foundation has been laid in phase I.

The novel features of the various embodiments, as well as the invention itself, both as to its structure and its operation, will be best understood from the accompanying non-limiting examples, taken in conjunction with the accompanying description.

### EXAMPLES

### Example 1

### The Basic Game

The fifty bricks are combined and placed in a convenient place such as the lid of the accompanying game box, the bag the brick set comes in, face down on the table for the less preferred embodiments having only one side printed, or another container, to form the brickyard (the bag, the box, a container, etc). One of the players is designated the inspector who draws one brick from the brickyard and places it in the middle of the playing area, or site. This brick will be the cornerstone brick.

Each player, without looking, draws four bricks from the brickyard and places within the accompanying playing rack.

Play begins with the player to the left of the inspector. In the Basic game, play is similar to dominoes, however, using the header and footer having the unique rectangular bit configuration. Bricks are laid flat on the site and connections are made via a key bit to a slot bit or vice versa. For each connection, the player is awarded one point. The Basic game is played entirely horizontally or with all connections being made as in FIG. 3A, 116, 120, 122, or 124.

After all players have played their four bricks, four more bricks are drawn from the brickyard and play continues as before. Play continues until there are no longer enough bricks in the brickyard for every player to draw four. The winner is the player that accumulated the most connections and thus the most points.

### Example 2

### The Structural Game

The Structural game follows all of the rules of the Basic game and additionally, introduces the three-dimensional possibilities of the present disclosure. Referring to FIG. 4, game cards are included with the game set and contain instructions and pictures of a three-dimensional structure 140, 142. The three-dimensional structures 140, 142 are merely representative and are not intended to be limiting. The structures may take the form of any three-dimensional structure capable of being constructed with the presently disclosed bricks. The instructions included on the game card dictate the direction of play and how the bricks are laid. Players therefore play in courses. A chart 144, 146 included on each card illustrates the courses, or directions, of the bricks and how to play them. Thus, on each player's turn, the player must play their brick in the next space indicated by the chart and oriented accordingly.

Play continues until the structure has been constructed according to the directions included on each individual game card. It is contemplated that players will create their own three-dimensional structures and the present disclosure, in an electronic embodiment, will facilitate the sharing of these three-dimensional structures over a network.

### Example 3

### The Challenge Game

The Challenge game follows all of the rules of the Basic game and in addition to introducing a three-dimensional aspect, also teaches the power of the face-to-face connection, FIG. 3A 118.

Referring to FIG. 5, game cards are included with the game set and contain instructions and pictures of a three-dimensional structure 148, 150. In the Challenge game, each player draws one brick. The starting player is designated the defender and all other players the challengers. The Challenge game is also played in courses, or levels 152, 154, according to the individual game card chosen for play.

Play begins with the defender placing a brick according to the game card instructions. The challengers continue the course according to the game card instructions. The winner of each course is the challenger with the most connections, or the defender if no challenger makes five connections. After each course, a new, non-scoring brick is laid according to the game card instructions and play continues as before. Play continues until the brickyard is empty or the structure collapses.

### Example 4

### The Strategy Game

The Strategy game is the most advanced game and applies all of the rules of the Basic game and all vertical construction moves as illustrated in FIGS. 3A & 3B. The inspector for the Strategy game is tasked with keeping track of all the used and unused connections and must do so without moving any bricks. In the event it cannot be determined whether a connection has been scored, it is assumed such connection has been made and is no longer available.

The Strategy game is played in phases. A phase is the number of turns it takes for the players, drawing four bricks each turn, to run out of bricks. Thus, using one fifty brick game set, a two player game will have six phases, a three player game will have four phases, and a four player game will have three phases.

Each phase represents an opportunity to take the game to the next level. A level is defined as the height of one brick, standing on end. Any brick that is entirely above the height of one brick standing on end is considered to be on the next level. Referring to FIG. 6, illustrative of the varying ways to advance to the next level in the Strategy game.

The importance of advancing to the next level is the ability to multiply the number of connections made by the current level the connections were made on. Thus, when making connections, the highest level of any brick in a move represents the level of that move.

Play begins in phase I with the foundation. All bricks in phase I are played according to the rules of the Basic game and therefore no vertical moves are permitted. The game begins when the inspector is selected. The player(s) or groups of players can determine whether the game will be played in a clockwise direction or counterclockwise direction. The inspector will place the first brick and the game will proceed accordingly. Each player examines where to position their brick to make as many connections in a single play as possible. When all players have used all four bricks the foundation is laid and the next level is ready to be built. Beginning with phase II, all the Rules of the Basic game and vertical construction rules apply. In addition, beginning in phase II, players are allowed to play their bricks one at a time or three at a time. The three-brick move quickly advances the game to the next level.

Referring again to FIG. 6, representative three-brick moves are illustrated at 156 and 158. Because the horizontal brick played in the three-brick move in 156 and 158, is entirely above the height of one brick, standing on end, the connections made during the three-brick move 156, 158, would be multiplied by two and three respectively. For example, if the three-brick move 156 made four connections, the scoring for that move would be (2×4) for 8 total points. Similarly, a three-brick move 158 making four connections would result in a score of 12 total points (3×4). The value of moving to the next level and the strategy involved in advancing the game to maximize totals points available is highlighted by the foregoing example.

Because the Strategy game is based upon a game set containing fifty bricks, there will be two additional bricks available as wild bricks. The wild bricks can be purchased for extra points accumulated during any level of play and are the same in appearance as standard bricks. The purchase price for one wild brick is 8 points during the foundation level and goes up with each additional level, the level being the multiplier. These wild bricks can be bought in turn on any level and held for play on any level. The wild bricks are not mandatory to play.

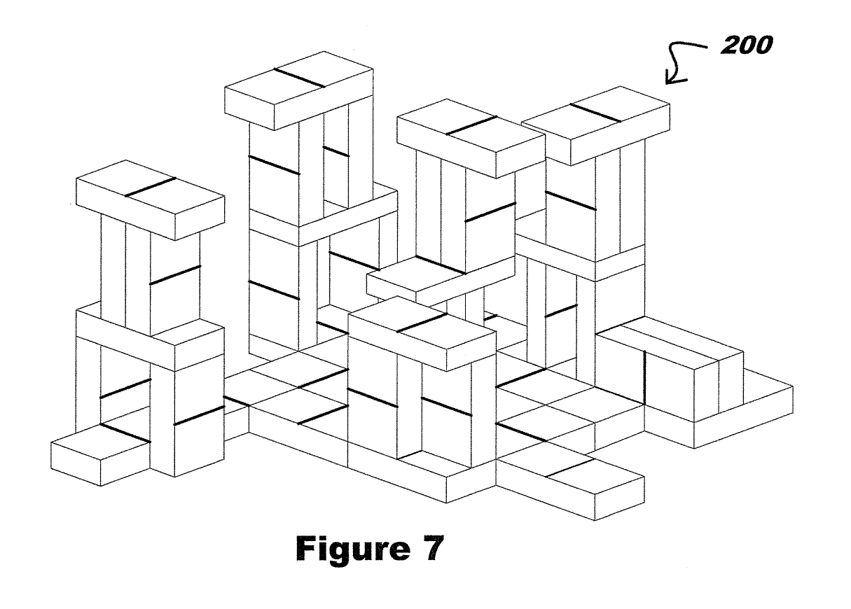

Referring now to FIG. 7, a representative game 200 is illustrated depicting what the Strategy game may look like after several phases of play. The game concludes when all bricks are played. The winning player or team is the one with the most points.

Although the foregoing examples are described in relation to a board game, alternative embodiments of the board game are contemplated. In one embodiment, a playing surface can be constructed or the bricks can be modified to determine connections, calculate scores, or add special effects such as sound. An electrical connection may be added to a brick to illuminate a successful connection. Applying techniques well known in the art, electrical components can be added to the brick to alert when a correct connection is made. The electrical components may include an LED light or any other source that could provide illumination of the game piece at the correct location to show the used portion of the brick.

The bricks may optionally include one or more visual indicators, such as color, design, letters, texture, and numbers. For example, a brick may have a color (such as blue) and a number (such as 2). In addition, identification components can also be added to molded bricks or bricks made from two halves. Radio Frequency Identifier (RFI) chips, or other well known devices in the art, that are encoded to each game pattern design may be embedded in each brick. These RF chips help locate each brick in relation to another brick on the playing surface. As each brick is played, each horizontal and vertical position is located and identified for correct connections and scoring.

The bricks may also be modified to include a sound emitting device when a successful connection is made. In this embodiment, if a proper connection is made, a sound is emitted confirming the proper connection. Conversely, when an incorrect connection is made a sound is emitted confirming the improper connection. The sound emitting device may be configurable to emit a verbal confirmation or any sound appropriate to denote proper and improper connections.

In another embodiment, the game may be adapted for electronic play. Adapting the game for use electronically allows the user(s) to play in almost any location in an individual or multi-player environment. The degree of special effects and design provides an exponential variety of playing options. Some possible dimensions of the game include but are not limited to the following:
Personal Communication Devices (iPhone®, etc.);
Public gaming machines (video arcade games);
Pay Per Play Venues (Internet and cable TV programming);
Controlled Casino betting machines (slot machines);
Controlled Lottery (power ball and state lottery);
Personal gaming devices (Nintendo®, X Box®, Game Boy®, etc.); and
Television game show adaptations.

In the electronic embodiment, the method disclosed herein may be implemented as a combination of hardware and software. The method disclosed herein is accessed and operated through the internet via a website accessible by a user through a standard internet browser. Any combination of computing devices, personal gaming devices, etc. may access the internet through a cable modem, a DSL modem, a dial-up modem, or a wireless router based on the various IEEE standards 802.x, where x denotes the various present and evolving wireless computing standards, for example IEEE 802.11; 802.11a, b, g, n; WiMax IEEE 802.16 and WRANG IEEE 802.22. Alternatively, digital cellular communications formats compatible with for example GSM, 3G, CDMA, TDMA and evolving cellular communications standards may be implemented.

In the electronic embodiment, players will select a skill level of play. Based upon the skill level of the player, a timer element will be triggered. Players will be tasked with placing a brick in the correct position and orientation within that time limit. The faster the player places the brick, the more structural integrity the particular game being played possesses. In addition, the timer element may be tied to the speed of the fall of a brick towards the site. This embodiment is particularly useful in personal gaming devices and multiple player scenarios over a computer network.

The various components of the game set may be constructed from any suitable material and therefore, may result in variation in overall design to the size, shape, texture, color, material, etc. of the bricks and accompanying game pieces. In the preferred embodiment, the bricks are constructed of expanded PVC. Use of expanded PVC creates a surface ideal for imprinting the various bit designs and creating a friction surface on the sides and ends of each brick facilitating the construction of three-dimensional structures of varying heights. The various bit designs may be etched, carved, imprinted, painted, or affixed to the surface of the bricks made from any number of available materials. The material used to construct the bricks will dictate the appropriate method of applying the bit designs and is well known to one of ordinary skill in the art without undue experimentation.

Solid or opaque bricks can be made from many different materials which include natural wood species and man made composites. The different “mediums” available are all common to the marketplace. Wood species and wood composites provide a solid brick shape in which the two face surfaces can be covered with the combination of header and footer game designs. These game designs are required for players to view the front and back and place their bricks for making a play, whether horizontally or vertically. Different wood species or the composite materials can be used to change the brick color for a constant or exotic presentation.

Transparent bricks are another way to play the game. The use of clear materials such as acrylic, glass or plastics allows each player the ability to see the single game design image to make a play. The design can be etched by laser, or any other etching means known in the art, into the core of the brick or a printed design on plastic film can be pressed between two halves to form the brick.

The use of the transparent bricks facilitates a unique illuminating effect while the game is being played through the use of a light source in the table or playing surface or within the brick itself. This use of light brings out the color or etched design in the bricks with greater detail.

The use of foam materials may be desired for younger children. The brick design is the same as the solid hard bricks, but can be handled safely by younger players. The foam bricks are typically larger for ease of use. There is no chocking hazard and the bricks are more age appropriate for the given skill set in younger children. A variety of brick color and design patterns can be achieved by foam materials and techniques well known in the art.

While this invention has been particularly shown and described with references to preferred embodiments thereof, it will be understood by those skilled in the art that various changes in form and details may be made therein without departing from the scope of the invention encompassed by the appended claims.

The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be performed by those skilled in the art, and that such modifications and variations are considered to be within the scope of the inventions disclosed herein. The inventions have been described broadly and generically herein. Each of the narrower species and subgeneric groupings falling within the scope of the generic disclosure also form part of these inventions. This includes the generic description of each invention with a proviso or negative limitation removing any subject matter from the genus, regardless of whether or not the excised materials specifically resided therein.

In addition, where features or aspects of an invention are described in terms of the Markush group, those schooled in the art will recognize that the invention is also thereby described in terms of any individual member or subgroup of members of the Markush group. It is also to be understood that the above description is intended to be illustrative and not restrictive. Many embodiments will be apparent to those of ordinary skill in the art from consideration of the specification and practice of the invention disclosed herein. It is intended that the specification and examples be considered as exemplary only, with a true scope and spirit of the invention being indicated by the claims along with the full scope of equivalents to which such claims are entitled. The disclosures of all articles and references, including patent publications, are incorporated herein by reference.

I claim:

1. A method of playing a three dimensional construction family game, for at least first and second players, using a plurality of bricks, each brick having a top surface and a bottom surface, two sides and two ends, the bricks having a depth, width and length, the depth less than the width and the width less than the length, the top and bottom surfaces defined by the width and length, the sides defined by the length and depth and thus smaller in area than the top and bottom surfaces, the ends defined by the depth and width and thus smaller in area than the sides, the bricks defined to be flat when placed with either the top surface or bottom surface upward; the bricks defined to be upright when placed with either end upward; the bricks defined to be on the side when placed with either side upward; adjacent defined to mean a first and a second brick adjoining with neither brick resting on the other, and atop defined to mean the second brick resting on the first brick; wherein forming a part of the top surface of each brick is at least one bit, each bit having either a key or slot configuration, said method comprising the steps of:
each such player selecting a plurality of game bricks;
positioning a first game brick comprising the first such player's first turn;
the second such player taking a turn comprising establishing a connection to the first game brick by positioning a second brick so that at least one bit of the second brick is adjacent or atop at least one bit of the first brick, and at least one bit of one of the two bricks is a key while the bit of the other brick is a slot;
the first such player and the second such player continuing to play by alternating the turns, on each one of the turns placing one additional brick so as to establish an additional connection;
awarding points to the first such player and the second such player for establishing connections of the game bricks;
wherein the key of one brick and the slot of another brick may make at least the following types of connections, each type of connection being distinct:
both bricks flat,
the first brick flat and the second brick upright,
the first brick flat and the second brick upright and atop the end of the upper surface of the first brick,
the first brick flat and the second brick upright and atop a non-end portion of the upper surface of the first brick,
the first brick flat and the second brick on its side,
the first brick flat and the second brick on its side atop the upper surface of the first brick,
the first brick on its side and the second brick on its side and atop the first brick.

2. A design and build construction family game for play in three dimensions building from a playing surface, the game comprising:
a plurality of bricks each brick having a top surface and a bottom surface, two sides and two ends, the bricks having a depth, width and length, the depth less than the width and the width less than the length, the top and bottom surfaces defined by the width and length, the sides defined by the length and depth and thus smaller in area than the top and bottom surfaces, the ends defined by the depth and width and thus smaller in area than the sides;
the bricks defined to be flat when placed with either the top surface or bottom surface upward;
the bricks defined to be upright when placed with either end upward;
the bricks defined to be on the side when placed with either side upward;
adjacent defined to mean a first and a second brick adjoining with neither brick resting on the other, and atop defined to mean the second brick resting on the first brick;
wherein forming a part of at least one top surface of each brick is at least one bit, the at least one bit having either a key or slot configuration;
a set of rules defining a connection to be made by positioning the second brick so that at least one bit of the second brick is adjacent or atop at least one bit of the first brick, and one brick's bit is a key while the bit of the other brick is a slot; and the bricks are oriented in any one of the following ways:
both bricks flat,
the first brick flat and the second brick upright,
the first brick flat and the second brick upright and atop the end of the upper surface of the first brick,
the first brick flat and the second brick upright and atop a non-end portion of the upper surface of the first brick,
the first brick flat and the second brick on its side,
the first brick flat and the second brick on its side atop the upper surface of the first brick,
the first brick on its side and the second brick on its side and atop the first brick.

3. The game of claim 2, wherein a mirror image of the at least one bit forming a part of the top surface forms a part of the bottom surface.

4. The game of claim 2, wherein each brick includes a plurality of bits.

5. The game of claim 4, wherein each brick includes between 2 and 8 bits.

6. The game of claim 5, wherein each brick includes 8 bits.

7. The game of claim 2, wherein each brick is partitioned into equal halves, each half including at least one bit.

8. The game of claim 7, wherein each half includes a plurality of bits.

9. The game of claim 8, wherein each half includes between 2 and 4 bits.

10. The game of claim 9, wherein each half includes 4 bits.

11. The game of claim 2, wherein a plurality of connections forms a three dimensional structure.

12. The game of claim 2, wherein the game includes at least 50 bricks.

13. The game of claim 2, wherein there is a plurality of bit configurations.

14. The game of claim 2, wherein the plurality of bricks are designed with a visual indicator, the visual indicator selected from at least one member of the group consisting of color, design, letters, texture, and numbers.

15. The game of claim 2, wherein the plurality of bricks includes electronic components selected from at least one member of the group consisting of a sound emitting device, illumination device, and a radio frequency identifier chip.

16. The game of claim 2, wherein the game is played electronically on a device selected from a member of the group consisting of mobile phone devices, smart phone devices, computing devices, mobile game stations, personal gaming devices, and arcade games.

17. The game of claim 16, wherein the game is played by a plurality of players over a computer network, wherein the device selected from a member of the group consisting of mobile phone devices, smart phone devices, computing devices, mobile game stations, personal gaming devices, and arcade games is connected to the computer network by a cellular broadband connection, a cable modem, a DSL modem, a dial-up modem, or a wireless router.
